(19) United States
(12) Patent Application Publication
(10) Pub. No.: US 2005/0146634 A1
(43) Pub. Date: Jul. 7, 2005

(54) Cameras, optical systems, imaging methods, and optical filter configuration methods

(76) Inventors: D. Amnon Silverstein, Mountain View, CA (US); Suk Hwan Lim, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/749,576

(22) Filed: Dec. 31, 2003

(51) Int. Cl. H04N 5/335

(52) U.S. Cl. 348/360

(57) ABSTRACT

Cameras, optical systems, imaging methods and optical filter configuration methods are described. According to one embodiment, a camera includes an image device configured to receive light of a subject and to provide an image representation of the subject from the light, wherein the image representation is usable to generate a visible image of the subject, a lens system optically coupled with the image device and configured to direct the light to the image device, wherein the image device is configured to generate the image representation while having a first sensitivity to a first wavelength of light and a second sensitivity to a second wavelength of light different than the first sensitivity, and a filter optically coupled with the lens system and corresponding to the image device wherein the filter is configured to pass a first quantity of photons having the first wavelength of light for the subject and a second quantity of photons having the second wavelength of light for the subject.

### BACKGROUND OF THE DISCLOSURE

Cameras and other image devices have been popular devices for decades. Features such as automatic focus and improved optics have made photography relatively straightforward for an increased number of users. More recently, advances in memory and electrical sensing devices have led to increased popularity of digital cameras for still and video imaging operations. Numerous advancements for these devices have been made including increased resolutions and improved processing speeds. Digital cameras enable users to efficiently communicate images through networks, memory devices, etc.

These digital cameras are used in an ever-increasing number of applications, and the popularity of these devices is expected to increase as the device capabilities increase and costs are reduced.

Some digital camera configurations have relatively poor sensitivity (quantum efficiency) to certain wavelengths of light. For example, some digital cameras utilize silicon sensor arrangements to generate images. These digital cameras may be less sensitive to light of shorter wavelengths (e.g., blue light) because the absorption coefficient of silicon is relatively high for short wavelengths resulting in generation of hole/electron pairs at shallow depths.

In some approaches, a camera may use a faster lens (small F# and/or large aperture), a longer exposure, increased electronic gain for blue light, or broadly tuned color filters for blue light to compensate for the low sensitivity to blue light. These approaches may lead to additional image problems, including increased expense or poor quality images using a faster lens, increased motion blur or saturation of well capacity of other channels using longer exposure periods, increased noise wherein the signal-to-noise ratio is not increased using increased gains, or utilization of high off-diagonal elements in color correction matrices that may amplify noise in conjunction with broadly tuned filters.

At least some aspects of the disclosure provide improved imaging systems and methods.

### SUMMARY

According to exemplary embodiments, cameras, optical systems, imaging methods and optical filter configuration methods are described.

According to one embodiment, a camera comprises an image device configured to receive light of a subject and to provide an image representation of the subject from the light, wherein the image representation is usable to generate a visible image of the subject, a lens system optically coupled with the image device and configured to direct the light to the image device, wherein the image device is configured to generate the image representation while having a first sensitivity to a first wavelength of light and a second sensitivity to a second wavelength of light different than the first sensitivity, and a filter optically coupled with the lens system and corresponding to the image device wherein the filter is configured to pass a first quantity of photons having the first wavelength of light for the subject and a second quantity of photons having the second wavelength of light for the subject.

According to another embodiment, an imaging method comprises receiving light of a plurality of wavelengths, first sensing the light having one of the wavelengths at a first sensitivity, second sensing the light having an other of the wavelengths at a second sensitivity greater than the first sensitivity, generating a plurality of electrical signals responsive to the first and the second sensings and corresponding to quantities of sensed light having the one and the other wavelengths, and prior to the first and the second sensings, filtering the light comprising passing photons of the light having the one and the other wavelengths, the passing comprising passing an increased number of photons of the light having the one wavelength for a given subject compared with a number of the photons of the light having the other wavelength for the given subject.

Other embodiments are described as is apparent from the following discussion.

### DESCRIPTION OF THE DRAWINGS

FIG. 1 is a functional block diagram of a camera according to one embodiment.

FIG. 2 is an illustrative representation of an optical system according to one embodiment.

FIG. 3 is an illustrative representation of an optical system according to one embodiment.

FIG. 4 is an illustrative representation of an exemplary optical filter according to one embodiment.

### DETAILED DESCRIPTION

At least some aspects of the disclosure accommodate imaging arrangements having different sensitivities to different wavelengths of light. Exemplary imaging arrangements include film-based cameras as well as digital cameras. At least one embodiment utilizes a filter having different apertures for different colors of light. In one example, a relatively large aperture for blue light is provided with one or more smaller apertures for non-blue light. The large aperture for blue light collects an increased number of blue photons compared with photons of other colors resulting in a higher signal-to-noise ratio for the blue channel and which is amenable for use in imaging arrangements which are less sensitive to blue light. Other embodiments are possible as discussed further below.

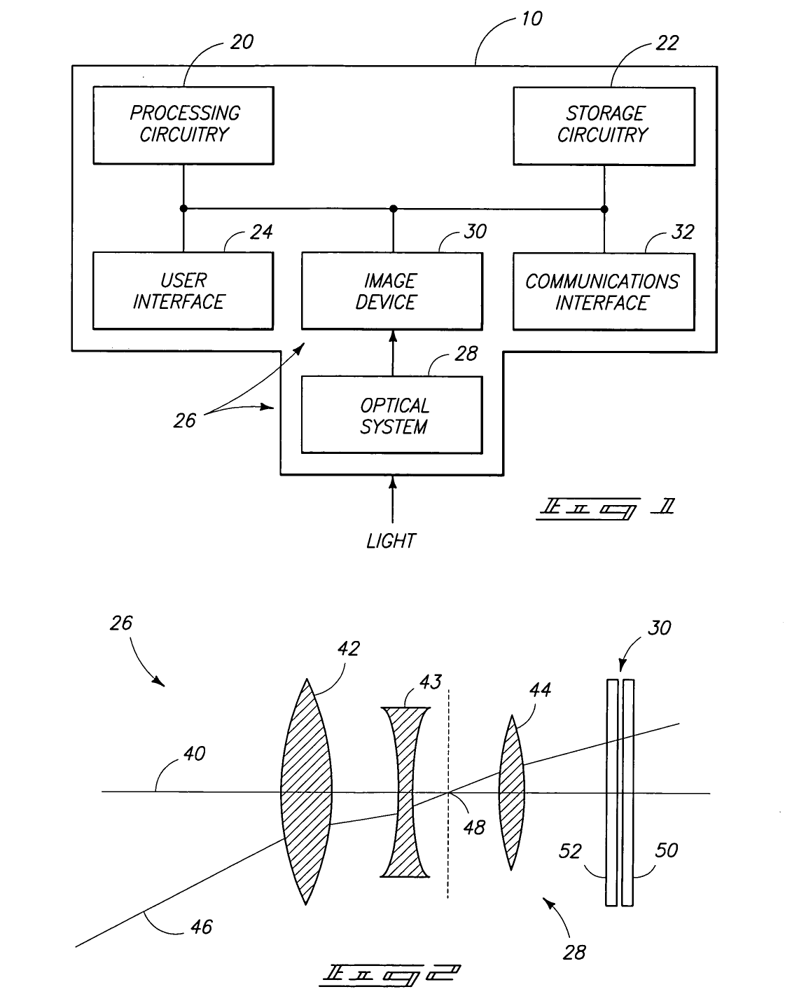

Referring to FIG. 1, an exemplary embodiment of an imaging arrangement configured as a camera 10 is shown. The arrangement of camera 10 is configured as a digital camera, however, other configurations including film-based cameras are possible as discussed above. The digital camera may be configured for use in still or video applications. The exemplary camera 10 includes processing circuitry 20, storage circuitry 22, a user interface 24, an imaging system 26, (including an optical system 28 and an image device 30 in one embodiment), and a communications interface 32 in the depicted embodiment.

Processing circuitry 20 is implemented as a microcontroller in an exemplary configuration. Processing circuitry 20 is configured to execute instructions to control operations of camera 10 and the generation of image data. Alternatively, processing circuitry 20 may be completely implemented in hardware. Additionally, processing circuitry 20 may control operations of user interface 24 including controlling the display of information using user interface 24 and the processing of inputted data received via user interface 24.

Storage circuitry 22 is arranged to store digital information and executable instructions. Storage circuitry 22 may include a buffer configured to receive raw raster image data from imaging system 26 and to store such data for processing. Storage circuitry 22 may also store instructions for execution by processing circuitry 20, or any other desired data in exemplary embodiments. Accordingly, storage circuitry 22 may include processor-usable media in one embodiment. Processor-usable media includes any article of manufacture which can contain, store, or maintain programming for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a magnetic computer diskette (e.g., floppy diskette, zip disk, hard disk), random access memory, read only memory, flash memory, erasable programmable read only memory, compact disk, or other configurations capable of storing programming, data, or other digital information.

User interface 24 is arranged to receive input from a user (e.g., buttons for tactile input) and also display information regarding camera 10 to a user (e.g., LCD display). Other configurations are possible.

Imaging system 26 is arranged to transform light of a subject into an image representation usable for visible image generation (e.g., photograph, electronic display, etc.). An exemplary optical system 28 may comprise a lens system and filter configured to receive light and to direct light to image device 30. Additional details regarding an exemplary configuration of optical system 28 are discussed below.

Image device 30 is configured to receive light of a subject (e.g., from optical system 28) and to provide an image representation of the subject which may be used to generate a visible image of the subject. As described further below, image device 30 may have different sensitivities to different wavelengths of light.

In a digital embodiment of camera 10, image device 30 comprises an electrical sensor configured to generate the image representation comprising electrical data or signals responsive to received light from optical system 28. Exemplary electrical data includes digital data for a plurality of pixels. In a film-based embodiment of camera 10, image device 30 may comprise film which is exposed by received light to provide the image representation.

Referring again to exemplary digital embodiments, an electrical sensor may comprise a charge-coupled device comprising an array of light sensitive elements. In another embodiment, the electrical sensor may comprise a sensor using Foveon X3 technology available from Foveon, Inc. The Foveon X3 image sensor technology comprises a full color sensor which provides full color (e.g., RGB) data at a plurality of pixel locations without interpolation. These exemplary arrangements of the electrical sensor comprise a semiconductive material such as silicon which has an increased coefficient of absorption with respect to light of a smaller wavelength (e.g., blue) compared with coefficients of absorption for light of larger wavelengths (e.g., red or green). Accordingly, and as discussed further below, an electrical sensor may be less sensitive to one wavelength of light (e.g., blue) compared with other wavelengths of light (e.g., non-blue light). Other electrical sensor arrangements may be utilized to convert light into electrical data. In film-based implementations, a given film may also have different sensitivities to different wavelengths of light.

Communications interface 32 is configured to implement communication of image and other data with respect to devices external of camera 10. In some arrangements, the image data may be communicated with or without internal storage of the image data using storage circuitry 22. The image data may be communicated to an external device, such as a receiver (not shown). Communications interface 32 may implement wired and/or wireless bi-directional communications in exemplary configurations.

Referring to FIG. 2, an exemplary arrangement of imaging system 26 including optical system 28 and image device 30 is shown. Other embodiments are possible.

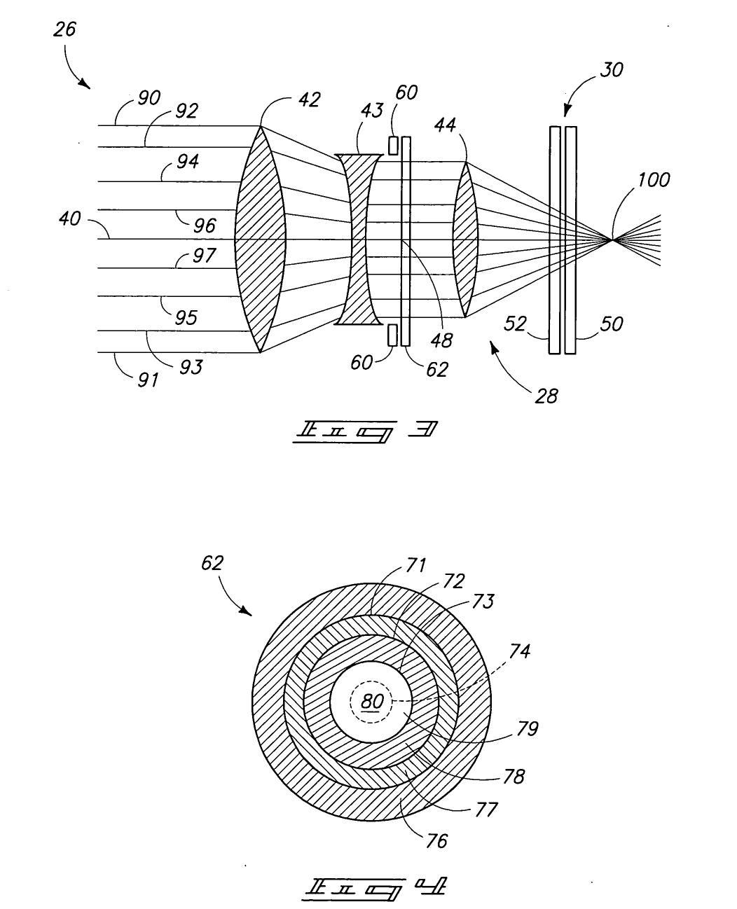

The exemplary optical system 28 is arranged as a triplet lens system about an optical axis 40 in the depicted embodiment. Optical system 28 is arranged to direct received light to image device 30. The triplet lens system includes a biconvex front lens 42, biconcave middle lens 43, and a biconvex back lens 44 aligned to optical axis 40. A chief ray 46 is illustrated intersecting optical axis 40 at a location 48 which may be referred to as an aperture stop. A filter may be located along optical axis 40 at location 48 in one embodiment. Exemplary details of the filter are discussed below with respect to one possible embodiment illustrated in FIGS. 3 and 4.

Image device 30 is aligned with optical axis 40 in the configuration of FIG. 2. Image device 30 is embodied as an electrical sensor 50 optically coupled with a filter 52 in the arrangement of FIG. 2. Filter 52 is configured to filter out some of the light received from optical system 28 in the depicted embodiment. For example, in one embodiment, filter 52 is configured to provide an RGB mosaic pattern wherein individual light sensing elements of electrical sensor 50 corresponding to individual pixels receive only one color of light red, green, or blue as defined by the filter 52. Accordingly, in one embodiment, image device 30 provides electrical data corresponding to a mosaic of different wavelengths of light for different pixels wherein an individual pixel comprises electrical data for an individual color or wavelength of light (e.g., red, green or blue). Processing may be implemented (e.g., using processing circuitry 20) to interpolate the data to fully populate color information providing red, green, and blue data for the individual pixels. Other arrangements are possible, for example, filter 52 may be omitted for applications wherein an electrical sensor 52 using Foveon technology is employed providing full color data at-individual pixel locations.

Referring to FIGS. 3 and 4, additional exemplary details of imaging system 26 are shown. In particular, FIG. 3 illustrates an iris 60 positioned adjacent to a filter 62 aligned at location 48 in the depicted embodiment. Iris 60 may be opaque to define a limiting aperture of the optical system 28 of variable radius in the illustrated embodiment. Iris 60 may be omitted in other embodiments.

Referring now to FIG. 4, filter 62 is configured according to the configuration of image device 30 utilized in camera 10 in one embodiment. For example, filter 62 may be configured to negate the effects of image device 30 having different sensitivities to different wavelengths of light in an effort to achieve substantially uniform data across the individual color channels in one embodiment. The exemplary filter 62 of FIG. 4 has a bullseye arrangement comprising a plurality of concentric annular rings of different radii configured to provide a plurality of aperture stops 71-74 at location 48 of optical axis 40 for different wavelengths of light. Aperture stops 71-74 comprise different sizes (e.g., different radii in the described example) and correspond to respective wavelengths of light in the described embodiment.

For example, filter 62 includes an opaque (e.g., black) ring 76 which defines aperture stop 71 for blue light. A blue-pass step filter ring 77 is provided to define aperture stop 72 stopping down red and green light and providing a wide aperture to pass blue light. A cyan filter ring 78 is provided to define aperture stop 73 for red light and to pass green and blue light. An infrared filter ring 79 may be provided to define aperture stop 74 to stop down infrared light and pass red, green and blue light. Some electrical sensors 50 are exquisitely sensitive to infrared light and provision of infrared filter ring 79 further restricts the aperture in the infrared range while still providing a quality image. In addition, utilization of infrared filter ring 79 reduces the requirements for lens performance at the infrared end of the spectrum. A substantially clear portion 80 of filter 62 is also provided in the depicted embodiment wherein no filtering of light occurs.

Accordingly, in the depicted embodiment, filter 62 provides a wide aperture for blue light, a medium aperture for green light and a small aperture for red light accommodating different sensitivities of image device 30. The exemplary configuration balances exposure needed for the respective colors while utilizing individual apertures which are as small as possible to provide improved depth of field and aberration reduction. Other embodiments of filter 62 are possible in other arrangements including more or less rings, alternate geometries, filtering of other colors, or other desired arrangements.

According to one aspect, filter 62 may be configured according to the image device 30 being utilized. The sensitivity of the image device 30 to different wavelengths of light may be determined and defined in a plurality of respective relationships. Thereafter, filter 62 may be configured to pass more light through a larger aperture for a wavelength of light wherein the image device 30 is less sensitive and less light through a smaller aperture for a wavelength of light wherein the image device 30 is more sensitive. Other configuration implementations are possible.

Referring again to FIGS. 3 and 4, exemplary filtering aspects of filter 62 are described with respect to a plurality of light rays including a top marginal blue ray 90, a bottom marginal blue ray 91, a top marginal cyan ray 92, a bottom marginal cyan ray 93, a top marginal white ray 94, a bottom marginal white ray 95, a top marginal infrared ray 96, and a bottom marginal infrared ray 97.

All light rays passing through clear portion 80 are unfiltered in the described embodiment. Infrared filter ring 79 filters infrared light and substantially passes all other light corresponding to the top and bottom marginal infrared rays 96, 97. Cyan filter ring 78 operates to stop down the red light as indicated by the top and bottom marginal red rays 94, 95 while passing green and blue light. Annular blue-pass step filter 77 operates to stop down the cyan light as indicated by the top and bottom marginal cyan rays 92, 93 while passing blue light. Black ring 76 operates to stop down the blue light as indicated by the top and bottom blue rays 90, 91. In one embodiment, the different filters 77-79 pass different numbers of photons of light for a given subject being imaged (e.g., filter 62 passes an increased number of blue photons having a smaller wavelength and corresponding to rays 90-91 compared with infrared photons having a larger wavelength and corresponding to rays 96-97).

Utilization of filter 62 provides camera 10 having different apertures for different colors of light. In the described exemplary embodiment, a large (e.g., having an increased radius) aperture for blue light is provided with one or more smaller apertures for non-blue light. The large aperture for blue light collects an increased number of blue photons compared with collection of photons of other colors resulting in a higher signal-to-noise ratio for the blue channel.

As illustrated by an exemplary focal point 100 along optical axis 40 of FIG. 3, the blue image may suffer an increased amount of defocusing blur and other image aberrations compared with other non-blue images. However, the distortion is not visible inasmuch as the blur is restricted to the blue channel of the image. More specifically, according to the exemplary described filter 62, the image has an improved depth of field in the red and green channels and blue has relatively less depth of field while passing an increased number of photons. As mentioned previously, electrical sensor 50 may be less sensitive to blue light compared with red and green light facilitating setting of exposure time. The relatively small apertures for red and green light minimize aberrations where they are most visible in the red and green channels and any increase in blur or aberrations in the blue channel should not be objectionable in resultant images.

The heightened amount of blue light improves the noise characteristics and image quality of the blue channel (e.g., blue sky of an image) resulting in an image of overall improved quality. Further, a less expensive lens system may be utilized to provide images of heightened quality inasmuch as the lens system does not need to have very good performance throughout its full aperture in at least one embodiment.

The protection sought is not to be limited to the disclosed embodiments, which are given by way of example only, but instead is to be limited only by the scope of the appended claims.

1. A camera comprising:
an image device configured to receive light of a subject and to provide an image representation of the subject from the light, wherein the image representation is usable to generate a visible image of the subject;
a lens system optically coupled with the image device and configured to direct the light to the image device;
wherein the image device is configured to generate the image representation while having a first sensitivity to a first wavelength of light and a second sensitivity to a second wavelength of light different than the first sensitivity; and
a filter optically coupled with the lens system and corresponding to the image device wherein the filter is configured to pass a first quantity of photons having the first wavelength of light for the subject and a second quantity of photons having the second wavelength of light for the subject.

2. The camera of claim 1 wherein the image device comprises an electrical sensor configured to provide the image representation in the form of electrical data.

3. The camera of claim 2 wherein the electrical sensor comprises a plurality of pixels, and the electrical sensor is configured to provide the electrical data corresponding to a mosaic of different wavelengths for the pixels comprising the first and the second wavelengths.

4. The camera of claim 1 wherein the image device comprises film to provide the image representation.

5. The camera of claim 1 wherein the filter comprises a plurality of aperture stops of different sizes, wherein a first of the aperture stops is configured to pass light of the first wavelength and a second of the aperture stops is configured to pass light of the second wavelength, wherein the first of the aperture stops has a radius greater than a radius of the second of the aperture stops.

6. The camera of claim 5 further comprising a third of the aperture stops having a radius smaller than a radius of the second of the aperture stops and comprising the only one of the plurality of the aperture stops configured to pass infrared light.

7. The camera of claim 1 wherein the light having the first wavelength comprises blue light and the light having the second wavelength comprises non-blue light.

8. A camera comprising:
an electrical sensor configured to receive light of a subject and to provide electrical data corresponding to the received light, wherein the electrical sensor comprises silicon having a first coefficient of absorption for light having a first wavelength and a second coefficient of absorption for light having a second wavelength, wherein the first coefficient of absorption is larger than the second coefficient of absorption and the first wavelength is smaller than the second wavelength; and
a filter optically coupled with the electrical sensor and configured to pass a first quantity of photons having the first wavelength of light for the given subject and a second quantity of photons having the second wavelength of light for the subject, wherein the second quantity of photons is less than the first quantity of photons.

9. The camera of claim 8 wherein the electrical sensor comprises semiconductive material having the first coefficient of absorption with respect to blue light.

10. The camera of claim 8 wherein the electrical sensor comprises a charge coupled device.

11. The camera of claim 8 wherein the filter comprises a plurality of aperture stops of different sizes, wherein a first of the aperture stops is configured to pass light of the first wavelength and a second of the aperture stops is configured to pass light of the second wavelength, wherein the first of the aperture stops is greater than the second of the aperture stops.

12. The camera of claim 11 wherein the aperture stops are concentric.

13. The camera of claim 12 further comprising a third of the aperture stops smaller than the second of the aperture stops and the only one of the plurality of the aperture stops configured to pass infrared light.

14. The camera of claim 8 wherein the electrical sensor comprises a plurality of pixels, and the electrical sensor is configured to provide the electrical data corresponding to a mosaic of different wavelengths for the pixels.

15. An optical system comprising:
lens means for receiving light having a plurality of wavelengths and for directing the light to an image means; and
filter means optically coupled with the lens means and comprising means for providing a first aperture stop having a first radius for blue light and a second aperture stop having a second radius different than the first radius for non-blue light, wherein the first radius of the first aperture stop is larger than the second radius of the second aperture stop.

16. The system of claim 15 further comprising the image means comprising means for receiving light of a subject from the lens means and for providing an image representation of the subject usable to generate a visible image of the subject.

17. The system of claim 15 wherein the image means comprises means for providing the image representation comprising electrical data for a plurality of pixel locations individually comprising image data for one of blue light and non-blue light.

18. The system of claim 15 wherein the first and the second aperture stops are configured to pass an increased number of photons of blue light compared with non-blue light.

19. The system of claim 15 wherein the first and the second aperture stops are concentric.

20. The system of claim 15 wherein the filter means further comprises a third aperture stop having a third radius smaller than the second radius and comprising the only one of the aperture stops for passing infrared light.

21. An imaging method comprising:
receiving light of a plurality of wavelengths;
first sensing the light having one of the wavelengths at a first sensitivity;
second sensing the light having an other of the wavelengths at a second sensitivity greater than the first sensitivity;
generating a plurality of electrical signals responsive to the first and the second sensings and corresponding to quantities of sensed light having the one and the other wavelengths; and
prior to the first and the second sensings, filtering the light comprising passing photons of the light having the one and the other wavelengths, the passing comprising passing an increased number of photons of the light having the one wavelength for a given subject compared with a number of the photons of the light having the other wavelength for the given subject.

22. The method of claim 21 wherein the first and the second sensings and the generating comprise using at least one sensing device comprising silicon.

23. The method of claim 21 wherein the first and the second sensings and the generating comprise using at least one sensing device comprising a charge coupled device.

24. The method of claim 21 wherein the one wavelength is smaller than the other wavelength.

25. The method of claim 21 wherein the sensing the light having one of the wavelengths comprises sensing blue light and the sensing the light the other of the wavelengths comprises sensing non-blue light.

26. The method of claim 21 wherein the filtering comprises filtering using a filter comprising a plurality of aperture stops of different sizes, wherein a first of the aperture stops is configured to pass light of the first wavelength and a second of the aperture stops is configured to pass light of the second wavelength.

27. The method of claim 26 wherein the aperture stops are concentric.

28. The method of claim 21 wherein the first sensing comprises sensing at a plurality of first pixels corresponding to the one wavelength and the second sensing comprises sensing at a plurality of second pixels corresponding to the other wavelength.

29. The method of claim 21 further comprising filtering infrared light providing a smaller number of photons for infrared light compared with light of the other wavelength for the given subject.

30. An optical filter configuration method comprising:
identifying a sensor for use with a filter, wherein the sensor is configured to generate electrical data responsive to received light of different wavelengths;
for the identified sensor, determining individual ones of a plurality of sensitivity relationships of the sensor with respect to different ones of the wavelengths of light;
responsive to the determining, configuring the filter to pass a first quantity of photons of a given subject for a first wavelength of light; and
responsive to the determining, configuring the filter to pass a second quantity of photons of the given subject for a second wavelength of light different than the first wavelength of light.

31. The method of claim 30 wherein the configurings comprise configuring the filter to pass an increased number of blue photons compared with respective numbers of individual colors of non-blue photons.

32. The method of claim 30 wherein the sensor comprises silicon having an increased coefficient of absorption of blue light compared with individual ones of red light and green light.

33. The method of claim 30 wherein the configurings comprise configuring the filter to pass an increased number of blue photons compared with green photons.

34. The method of claim 33 wherein the configurings comprise configuring the filter to pass an increased number of blue photons compared with red photons.

35. The method of claim 30 further comprising configuring the filter to pass a third quantity of infrared photons for the given subject less than individual ones of the first quantity and the second quantity.

36. The method of claim 30 wherein the determining comprises determining the sensor having an increased sensitivity to blue light compared with individual ones of red light and green light, and wherein the configurings comprise configuring the filter to pass an increased quantity of blue photons compared with individual ones of red photons and green photons.

37. The method of claim 30 wherein the first wavelength is less the second wavelength and the first quantity is greater than the second quantity.

38. The method of claim 37 wherein the filtering comprises filtering using a filter comprising a plurality of aperture stops of different sizes, wherein a first of the aperture stops is configured to pass light of the first wavelength and a second of the aperture stops is configured to pass light of the second wavelength.

39. The method of claim 38 wherein the aperture stops are concentric.
